(19) United States
(12) Patent Application Publication
(10) Pub. No.: US 2008/0047112 A1
(43) Pub. Date: Feb. 28, 2008

(54) Clip assembly for fuel door release cable

(76) Inventor: Theodore Calvin Hoekstra, Chatham (CA)

Correspondence Address: MILLER THOMSON LLP, 100 STONE ROAD WEST, SUITE 301, GUELPH, ON, N1G-5L3, US

(21) Appl. No.: 11/892,208

(22) Filed: Aug. 21, 2007

Related U.S. Application Data
(60) Provisional application No. 60/823,195, filed on Aug. 22, 2006.

(51) Int. Cl. F16G 11/00

(52) U.S. Cl. 24/457

(57) ABSTRACT

A clip assembly for fuel door release cable system having a first clip portion having a first end and a second end where the first and second ends each have an aperture with defined curved surfaces adapted to receive and engage the fuel door release cable system. The clip assembly further includes a second clip portion having a first end and a second end where the first and second ends each have an aperture with defined curved surfaces adapted to receive and engage the fuel door release cable system. The first and second clip portions snap-fit together around the fuel door release cable system.

### FIELD OF THE INVENTION

The present invention relates to the repair of a release cable used to remotely open a fuel door in car vehicles. In particular, the invention relates to a clip assembly that is installed directly over a damaged cable. This effects a complete repair and obviates the expensive need to completely uninstall and replace the damaged cable.

### BACKGROUND OF THE INVENTION

The remote release of a vehicle's fuel door by means of a cable is well known. Typically the release cable mechanism is located adjacent the driver's seat on the floor of the vehicle and features a release lever which the occupant manually operates to remotely release the fuel door.

The release cable itself consists of an outer cable and an inner cable. In principle, the operation of the release lever moves the inner cable relative to the outer cable. Ultimately, it is the relative linear movement of the inner cable that is the action which releases the fuel door from its locked position.

The cable release mechanism comprises a housing, which is attached to the body of the vehicle. Included within the housing are means to receive the outer cable in order to secure it within the mechanism. A release lever is pivotally mounted on the mechanism and is connected to the inner cable. The manual operation of the release lever moves the inner cable relative to the outer cable, which action releases the locking mechanism at the fuel door (not shown).

Means must be accordingly provided at the end of the outer cable to permit its attachment to a complementary receiving means within the cable release mechanism housing, to thereby permit the relative movement of the inner cable by means of the release lever. Otherwise both cables would move in response to the movement of the release lever and there would be no relative movement and hence no mechanical action to open the fuel door.

This is typically done by attaching a plastic sleeve to the outer cable by means of a crimping collar. The plastic sleeve is suitably configured to enable its securement within the cable release mechanism and remains connected to the outer cable by means of the crimping collar. Because the inner cable is separately and operatively attached to the release lever its operation moves the inner cable relative to the outer cable to release the fuel door.

Typically, cable failure occurs at the crimping collar because of fatigue and/or rust. In any event, the crimping collar is prone to failure. When failure occurs the operation of the release lever moves both the inner cable and outer cables together and the lock mechanism of the fuel door is no longer releasable.

Presently no method of repairing the release cable in situ exists and replacement of the entire cable is required. This is a time-consuming and expensive operation. A more efficient and less costly method of repairing the failed cable assembly is required.

### SUMMARY OF THE INVENTION

The object of the present invention is to use the inventive clip to reconnect the outer cable to the plastic sleeve at the point of failure at the crimping collar. A simple and inexpensive fix is thereby effected.

In accordance with one aspect of the present invention there is provided a clip assembly for fuel door release cable system having a first clip portion having a first end and a second end where the first and second ends each have an aperture with defined curved surfaces adapted to receive and engage the fuel door release cable system. The clip assembly further includes a second clip portion having a first end and a second end where the first and second ends each have an aperture with defined curved surfaces adapted to receive and engage the fuel door release cable system. The first and second clip portions snap-fit together around the fuel door release cable system.

Preferably the curved surfaces may be further defined as shoulders at both the first end and the second end of the first and second clip portions. Furthermore the first and second clip portions may include a locking means for the snap-fitting the first and second clip portions together. Conveniently the locking means may be a locking tab having a complimentary slot that engage on each clip portion to secure the clip assembly to the fuel door release cable system.

Advantages of the present invention include an effective repair mechanism, easy to install, does not require a mechanic, inexpensive compared to a traditional repair procedure, and inexpensive to manufacture.

### BRIEF DESCRIPTION OF THE DRAWINGS

In order that the invention may be more clearly understood, embodiments thereof will now be described in detail by way of example, with reference to the accompanying drawings, in which:

FIG. 1 is a photograph of a failed crimping collar.

FIGS. 2 and 3 are schematic views showing the use of the clip of the present invention to effect a repair.

FIG. 4 is a cross-sectional view of the repaired release cable with the clip of the present invention applied thereon.

FIG. 5a is a perspective view of the fuel door release cable system of the present invention.

FIG. 5b is a perspective view of the first clip portion applied to the fuel door release cable system.

FIG. 5c is perspective view of the second clip portion being positioned for a snap fit to the fuel door release cable system and the first clip portion.

FIG. 5d is a perspective view of the clip assembly locked on to the fuel door release cable system.

### DESCRIPTION OF PREFERRED EMBODIMENTS

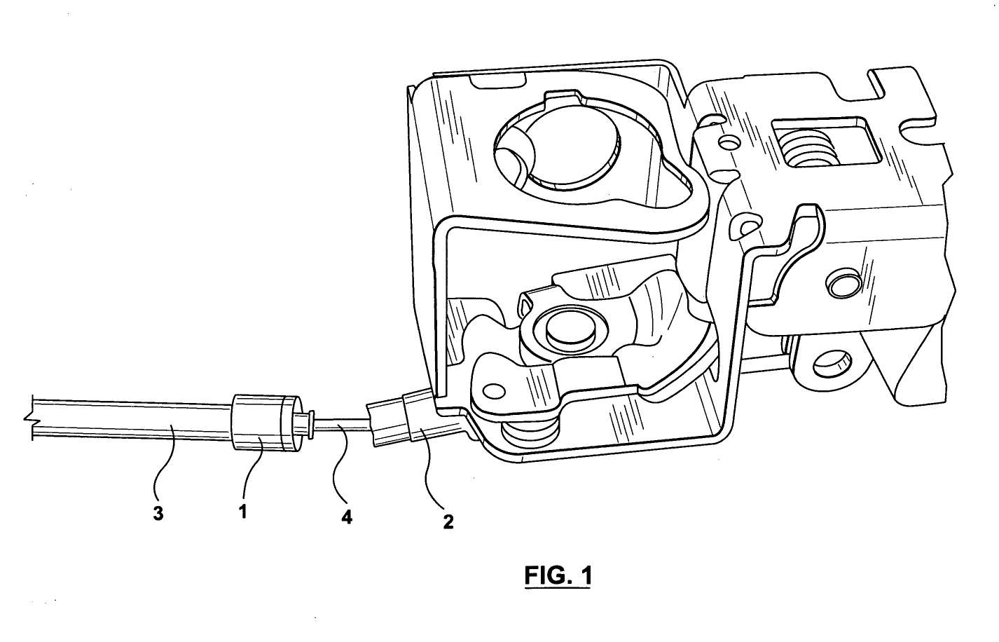

Referring to FIG. 1 a failed crimping collar 1 is shown, whereby the outer cable 3 has become detached from the plastic sleeve 2, exposing the inner cable 4.

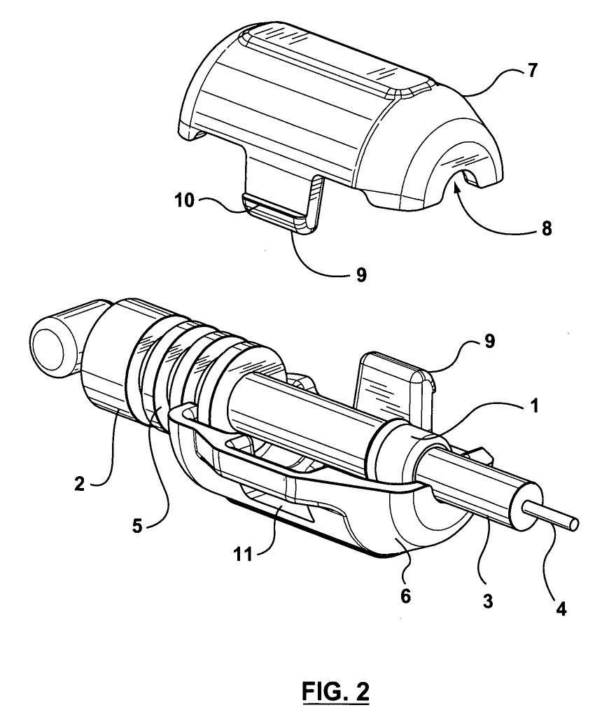

Referring to FIG. 2 plastic sleeve 2 is shown having adjustment slots 5, which securely fit into a complementary portion of the housing of the cable release mechanism (not shown), thus anchoring the outer cable 3 to the housing. The failed crimping collar 1, which typically remains attached to the outer cable 3, is shown in abutting contact with the plastic sleeve 2 at the point of failure.

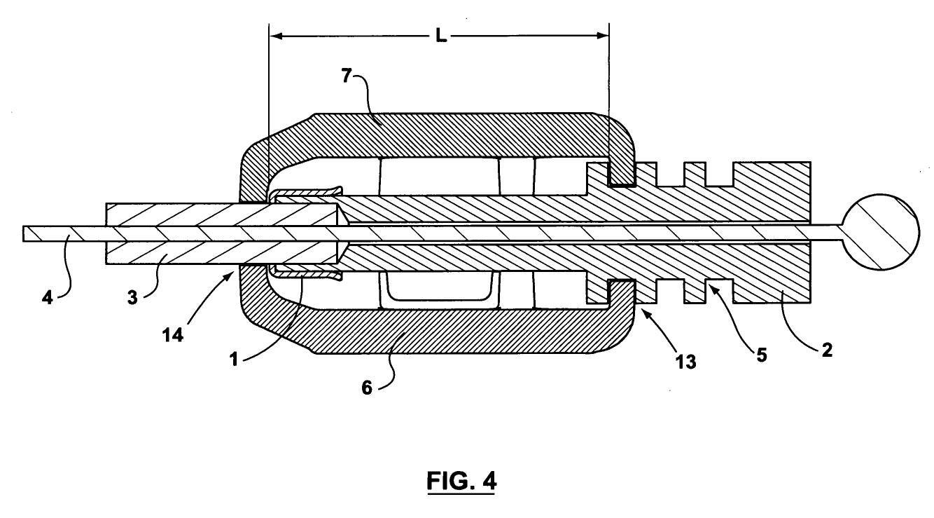

Referring to FIG. 2 two complementary portions 6 and 7 of the repair clip comprising the present inventions are shown. The two portions 6 and 7 are made of durable, injection molded plastic. As can be seen the clip portions 6 and 7 have aperture defining curved surfaces 8 at both ends. When the two clip portions 6 and 7 are connected to one another the surfaces 8 form an aperture having a shoulder or collar at each end, which, respectively, seat within the adjustment slot 5 at one end and behind the crimping collar I at the other. Accordingly, the inner length L (shown in FIG. 4) of the clip must be dimensioned exactly to permit the insertion of each half precisely as described and eliminate any relative movement between the crimping collar I, which remains attached to the outer cable 3 and plastic sleeve 2.

The method and means for connecting the two clip portions is now described. Referring to FIG. 2, each clip portion has locking tab 9 and complementary slot II. The two clip portions 6 and 7 are attached to one another by means of inserting each locking tab 9 within its complementary slot 11.

The locking action of the above-described tab/slot mechanism is accomplished by means of providing each outside face of the locking tabs 9 with a ledge 10. In operation each locking tab 9 is biased outwardly for insertion within its complementary slot. When fully inserted, the locking tabs 9 snap outwardly and are retained by means of the ledge 10 protruding outwardly within each slot II. The effect of these features is to create a snap-lock mechanism between the two clip portions. Removal of the repair clip is effected by the depression inwardly of the two locking tabs 9, followed by separation of the two clip portions. The snap-lock feature of the present invention makes the installation simple, fast and secure.

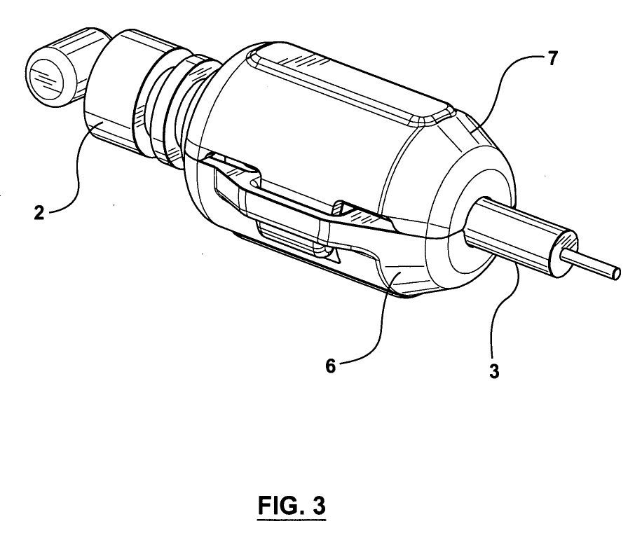

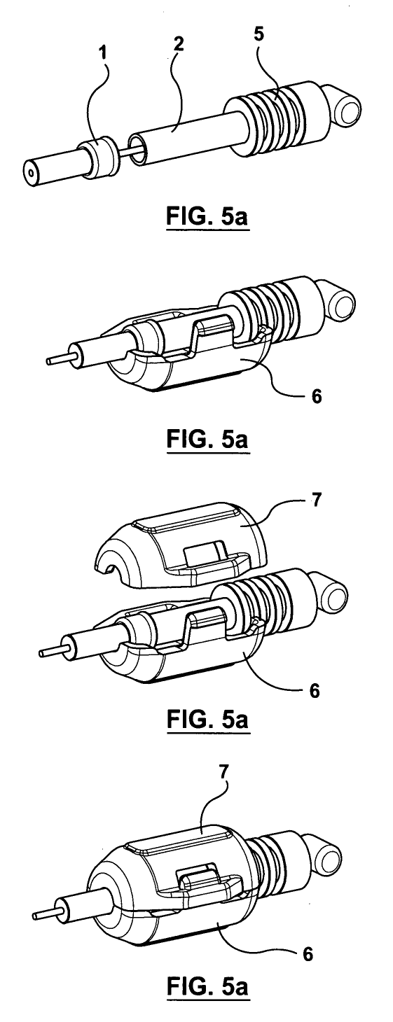

Referring to FIGS. 5a to 5d, in order to effect the repair, the clip is installed by fitting one end of each of the two clip portions 6 and 7 over an adjustment slot 5 and the other end over the outer cable 3 outwardly of the crimping collar 1. FIG. 3 shows the two portions 6 and 7 locked together.

Referring to FIG. 4 the diameter of the collar 13 of the clip at the plastic sleeve end is sized and shaped to that of the adjustment slot 5, such that the clip is securely retained within the slot 5. The diameter of the collar 14 of the clip at the crimping collar end is sized and shaped to that of the outer diameter of cable 3, such that the crimping collar 1 cannot move relative to the plastic sleeve 2. Hence, when the release lever is operated, the inner cable 4 is able to once again move relative to the outer cable 3, to release the locking mechanism of the fuel door (not shown).

One skilled in the art can appreciate that the present clip effects a repair of the failed cable release mechanism which is faster and cheaper than the replacement of the entire cable release mechanism. Another advantage of the present invention is that the two identical and complementary portions comprising the repair clip can be manufactured using the same injection mold, thereby making the clip cost effective to produce.

Other advantages, which are inherent to the structure, are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A clip assembly for fuel door release cable system comprising:
(a) a first clip portion having a first end and a second end wherein the first and second ends each have an aperture with defined curved surfaces adapted to receive and engage the fuel door release cable system; and
(b) a second clip portion having a first end and a second end wherein the first and second ends each have an aperture with defined curved surfaces adapted to receive and engage the fuel door release cable system;
wherein the first and second clip portions snap-fit together around the fuel door release cable system.

2. A clip assembly for fuel door release cable system as claimed in claim 1 wherein the curved surfaces are shoulders at both the first end and the second end of the first and second clip portions.

3. A clip assembly for fuel door release cable system as claimed in claim 2 wherein the first and second clip portions further comprise a locking means for the snap-fitting the first and second clip portions together.

4. A clip assembly for fuel door release cable system as claimed in claim 3 wherein the locking means is a locking tab having a complimentary slot.

5. A clip assembly for fuel door release cable system as claimed in claim 4 wherein the locking tab further includes a ledge adapted to engage the complimentary slot.

6. A clip assembly for fuel door release cable system as claimed in claim 5 wherein the locking tab is biased outwardly.

7. A clip assembly for fuel door release cable system as claimed in claim 6 wherein the first clip portion has the locking tab integral with the first clip portion and is adapted to biasely engage the complimentary slot on the second clip portion.

8. A clip assembly for fuel door release cable system as claimed in claim 6 wherein the first clip portion has the locking tab integral with the second clip portion and is adapted to biasely engage the complimentary slot on the first clip portion.

9. A clip assembly for fuel door release cable system as claimed in claim 2 wherein the shoulder at the first end of the first and second clip portions is adapted to receive and engage an adjustment slot of a sleeve of the fuel door release cable system.

10. A clip assembly for fuel door release cable system as claimed in claim 3 wherein the shoulder at the second end of the first and second clip portions is adapted to receive and engage a crimping collar of the fuel door release cable system.

11. A clip assembly for fuel door release cable system as claimed in claims 2 and 3 wherein the clip assembly is sized to eliminate relative movement between the crimping collar and the sleeve.
